(19) United States
(12) Patent Application Publication
(10) Pub. No.: US 2013/0148261 A1
(43) Pub. Date: Jun. 13, 2013

(54) CONDUCTIVE PASTE FOR EXTERNAL ELECTRODE, MULTILAYER CERAMIC ELECTRONIC COMPONENT USING THE SAME, AND METHOD OF MANUFACTURING THE SAME

(71) Applicants: Hye Seong KIM, Suwon (KR); Kyu Ha Lee, Suwon (KR); Byung Jun Jeon, Seoul (KR); Hyun Hee Gu, Yongin (KR); Jae Young Park, Seoul (KR); Da Young Choi, Suwon (KR); Eun Joo Choi, Suwon (KR); Myung Jun Park, Cheongju (KR); Chang Hoon Kim, Yongin (KR)

(72) Inventors: Hye Seong KIM, Suwon (KR); Kyu Ha Lee, Suwon (KR); Byung Jun Jeon, Seoul (KR); Hyun Hee Gu, Yongin (KR); Jae Young Park, Seoul (KR); Da Young Choi, Suwon (KR); Eun Joo Choi, Suwon (KR); Myung Jun Park, Cheongju (KR); Chang Hoon Kim, Yongin (KR)

(73) Assignee: SAMSUNG ELECTRO-MECHANICS CO., LTD.

(21) Appl. No.: 13/402,397

(22) Filed: Feb. 22, 2012

(30) Foreign Application Priority Data
Dec. 9, 2011 (KR) 10-2011-0131950

(51) Int. Cl. H01G 4/008; H01G 4/00; H01B 1/02

(52) U.S. Cl. 361/305; 252/512; 252/513; 252/514; 427/79

(57) ABSTRACT

There are provided a conductive paste for an external electrode, a multilayer ceramic electronic component using the same, and a method of manufacturing the same. More particularly, there are provided a conductive paste for an external electrode including: a conductive metal powder; and a spherical glass frit having an average particle size of 0.05 to 3.0 μm, a multilayer ceramic electronic component using the same, and a method of manufacturing the same. According to the present invention, a spherical glass frit having fine particles may be applied at the time of preparing the conductive paste for an external electrode, thereby realizing external electrodes having excellent compactness at a low temperature and suppressing the occurrence of cracks, and thus, a multilayer ceramic electronic component having excellent reliability can be implemented.

### CROSS-REFERENCE TO RELATED APPLICATIONS

This application claims the priority of Korean Patent Application No. 10-2011-0131950 filed on Dec. 9, 2011, in the Korean Intellectual Property Office, the disclosure of which is incorporated herein by reference.

### BACKGROUND OF THE INVENTION

1. Field of the Invention

The present invention relates to a conductive paste for an external electrode having excellent compactness, a multilayer ceramic electronic component using the same, and a method of manufacturing the same.

2. Description of the Related Art

In accordance with the recent trend for the miniaturization of electronic products, demand for multilayer ceramic electronic components having a small size and high capacitance has increased.

In accordance with the demand for miniaturization and high capacitance in multilayer ceramic electronic components, external electrodes thereof are also required to be thinner.

An external electrode paste employs a conductive metal such as copper (Cu) as a main material thereof, thereby securing chip air-tightness and electrical connectivity, and employs glass as an auxiliary material, thereby filling empty spaces formed during metal sintering shrinkage as well as providing bonding strength between the external electrode and the chip.

An oxide-based glass powder is generally used as the glass. The external electrodes are formed by coating end portions of the chip with external electrode paste and then sintering the external electrode paste thereon. Thereafter, a plating layer is formed by sequential electroplating of nickel (Ni) and tin (Sn).

However, as external electrodes are thinned, reliability thereof maybe deteriorated due to the penetration of a plating liquid at the time of the plating thereof.

In order to prevent the deterioration in reliability due to the penetration of the plating liquid, it is necessary to form compact external electrodes capable of resisting the penetration of the plating liquid.

To achieve this, the conductive metal powder used in the conductive paste for the external electrode is a fine grain type powder so as to improve corner coverage. However, in the case of using a glass frit, the particle size thereof is large and the shape thereof may not be uniform.

The glass frit, having large non-uniformly-shaped particles, is phase-changed to a liquid phase during an electrode firing procedure, and then moves to a metal grain boundary. Here, spaces in which the glass is present are present as large pores, causing compactness of the external electrode to be deteriorated.

However, when firing is performed at a high electrode firing temperature in order to prevent deterioration of this compactness, crack defects due to the diffusion of metal particles within the external electrode and volume expansion thereof may occur.

### SUMMARY OF THE INVENTION

An aspect of the present invention provides a conductive paste for an external electrode having excellent compactness, a multilayer ceramic electronic component using the same, and a method of manufacturing the same.

According to an aspect of the present invention, there is provided a conductive paste for an external electrode, including: a conductive metal powder; and a spherical glass frit having an average particle size of 0.05 to 3.0 μm.

The spherical glass frit may have an average particle size of 0.05 to 1.5 μm.

The glass frit may have a content of 0.1 to 200 volume % based on the conductive metal powder.

The glass frit may be provided in powder form, or in a core-shell form in which the glass frit is coated on a surface of the conductive metal powder.

A conductive metal for the conductive metal powder may be at least one selected from a group consisting of copper (Cu), nickel (Ni), silver (Ag), and silver-palladium (Ag—Pd).

According to another aspect of the present invention, there is provided a multilayer ceramic electronic component, including: a ceramic body including dielectric layers; first and second internal electrodes disposed to face each other with each dielectric layer interposed therebetween within the ceramic body; and a first external electrode electrically connected to the first internal electrodes and a second external electrode electrically connected to the second internal electrodes, wherein the first and second external electrodes include a conductive metal powder and a spherical glass frit, and the glass frit has a content of 0.1 to 200 volume % based on the conductive metal powder.

The spherical glass frit may have an average particle size of 0.05 to 3.0 μm.

The spherical glass frit may have an average particle size of 0.05 to 1.5 μM.

A conductive metal for the conductive metal powder may be at least one selected from a group consisting of copper (Cu), nickel (Ni), silver (Ag), and silver-palladium (Ag—Pd).

According to another aspect of the present invention, there is provided a method of manufacturing a multilayer ceramic electronic component, the method including: preparing a ceramic body including dielectric layers and first and second internal electrodes disposed to face each other with each dielectric layer interposed therebetween; preparing a conductive paste for an external electrode including a conductive metal powder and a spherical glass frit having an average particle size of 0.05 to 3.0 μm; applying the conductive paste for an external electrode to the ceramic body so as to be electrically connected to the first and second internal electrodes; and firing the ceramic body to form first and second external electrodes.

The spherical glass frit may have an average particle size of 0.05 to 1.5 μm.

The glass frit may have a content of 0.1 to 200 volume % based on the conductive metal powder.

The glass frit may be provided in powder form, or in a core-shell form in which the glass frit is coated on a surface of the conductive metal powder.

A conductive metal for the conductive metal powder may be at least one selected from a group consisting of copper (Cu), nickel (Ni), silver (Ag), and silver-palladium (Ag—Pd).

The firing of the ceramic body may be performed at a temperature of 700° C. or lower.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view schematically showing a conductive paste for an external electrode according to an embodiment of the present invention;

FIG. 2 is a perspective view schematically showing a multilayer ceramic capacitor according to another embodiment of the present invention;

FIG. 3 is a cross-sectional view taken along line A-A′ of FIG. 2;

FIG. 4 is a view showing a process of manufacturing the multilayer ceramic capacitor according to another embodiment of the present invention; and

FIG. 5 shows scanning electron microscope (SEM) paragraphs showing cross sections of external electrodes for individual firing temperatures according to inventive examples and comparative examples of the present invention.

### DETAILED DESCRIPTION OF THE PREFERRED EMBODIMENT

The embodiments of the present invention may be modified in many different forms and the scope of the invention should not be limited to the embodiments set forth herein. The embodiments of the present invention are provided so that those skilled in the art may more completely understand the present invention. In the drawings, the shapes and dimensions may be exaggerated for clarity, and the same reference numerals will be used throughout to designate the same or like components.

Embodiments of the present invention will now be described in detail with reference to the accompanying drawings.

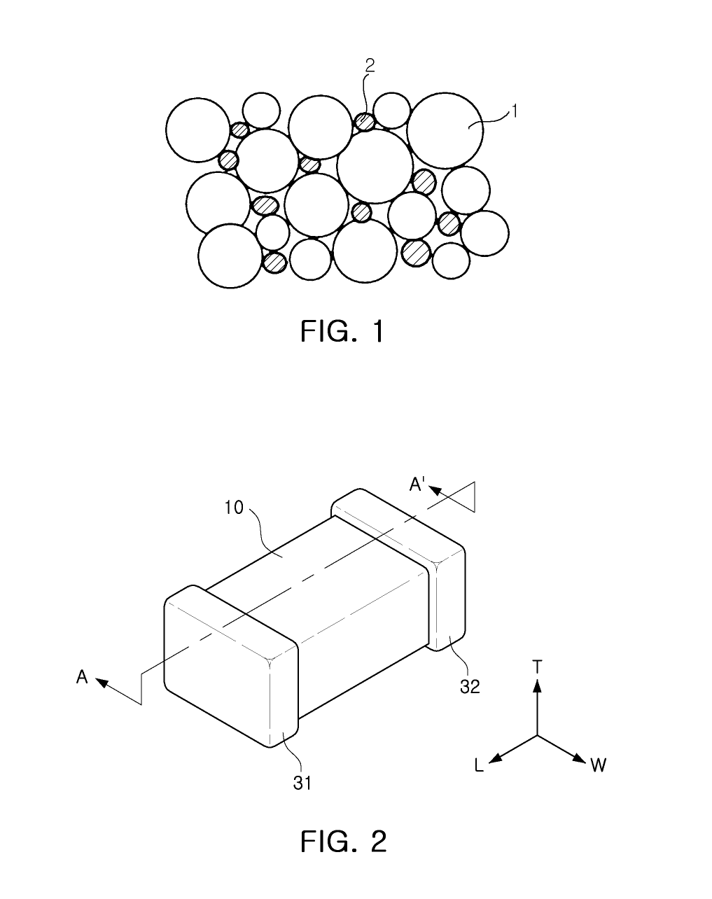

FIG. 1 is a schematic view schematically showing a conductive paste for an external electrode according to an embodiment of the present invention.

Referring to FIG. 1, a conductive paste for an external electrode according to the embodiment of the present invention may include a conductive metal powder 1; and a spherical glass frit 2 having an average particle size of 0.05 to 3.0 μm.

A conductive metal for the conductive metal powder 1 to form capacitance is not particularly limited, as long as it may be electrically connected to first and second internal electrodes 21 and 22. For example, the conductive metal may be at least one selected from a group consisting of copper (Cu), nickel (Ni), silver (Ag), and silver-palladium (Ag—Pd).

The conductive paste for an external electrode according to the embodiment of the present invention may include the spherical glass frit 2 having an average particle size of 0.05 to 3.0 μm.

The glass frit 2 may include fine particles having an average particle size of 0.05 to 3.0 μm, thereby realizing a thin film type external electrode having improved compactness.

In other words, in a case in which a conductive paste for an external electrode includes a non-uniformly-shaped glass frit having an average particle size of more than 3.0 μm, when a thin film type external electrode is formed by using the conductive paste, large non-uniformly-shaped glass particles may be present in the conductive paste.

As the result, the large non-uniformly-shaped glass particles are phase-changed to a liquid phase during an electrode firing procedure, and then move to a metal grain boundary. Here, spaces in which the glass particles were present are present as large pores, which cause compactness of the external electrode to be deteriorated.

In other words, when the non-uniformly-shaped glass frit is present in the external electrode, a close packing structure between conductive metal particles and the glass particles within the conductive paste may not be formed, to cause an increase in porosity in the conductive paste due to a reduction in packing density.

In this case, it is difficult to realize a compact external electrode after the firing of the external electrode.

In addition, the above defects may be solved by raising a firing temperature to induce diffusion of the conductive metal particles in order to prevent deterioration in compactness of the external electrode after the firing thereof, but in this case, cracks may occur due to diffusion of the conductive metal particles contained within the external electrode into an internal electrode and volume expansion thereof.

On the other hand, in a case in which the average particle size of the glass frit 2 is below 0.05 μm, there may be deterioration in reliability of the external electrode, such as crack defects or the like after the firing thereof due to the extremely small average particle size of the glass frit 2.

Therefore, according to the embodiment of the present invention, the conductive paste for an external electrode includes the spherical glass frit 2 having an average particle size of 0.05 to 3.0 μm, such that deterioration in compactness of the external electrode may be prevented even in the case in which electrode firing is performed at a low temperature, to reduce cracks occurrence after the firing, thereby resulting in excellent reliability.

In addition, in a case in which the conductive paste for an external electrode includes the spherical glass frit 2 having an average particle size of 0.05 to 1.5 μm, compactness of the external electrode and reliability thereof can be further enhanced.

Meanwhile, the glass frit 2 may have spherical shape.

According to the embodiment of the present invention, since the glass frit 2 has a uniform and spherical shape, a distance between the conductive metal powder 1 and the glass frit 2 is small within the conductive paste, thereby preventing deterioration in compactness of the external electrode.

In other words, in the case of using non-uniformly-shaped glass particles, distances between the conductive metal particles and the glass particles are irregular, resulting in deterioration in compactness of the external electrode after the firing of the external electrode. However, since the conductive paste for an external electrode according to the embodiment of the present invention includes uniform and spherical glass frit particles, thereby solving the above defects.

In addition, since deterioration in compactness of the external electrode may be prevented by using the uniform and spherical glass frit 2 even in the case in which firing of the external electrode is performed at a low temperature, a multilayer ceramic electronic component having excellent reliability can be realized in the case of using a conductive paste for the external electrode.

The method of forming the uniform and spherical glass frit 2 is not particularly limited, and for example, the method may be performed by melting and synthesizing a raw material constituting glass at a high temperature.

According to the embodiment of the present invention, the content of the glass frit is not particularly limited, but for example, the glass frit may have a content of 0.1 to 200 volume % based on the conductive metal powder.

If the content of the glass frit is below 0.1 volume % based on the conductive metal powder, the content of the glass frit is extremely low, and thus bonding defects between the chip and the external electrode may occur.

On the other hand, if the content of the glass frit is above 200 volume % based on the conductive metal powder, the content of the glass frit is extremely high to cause plating defects due to elution of the glass frit.

Meanwhile, the glass frit contained in the conductive paste for an external electrode maybe provided in powder form, or in a core-shell form in which the glass frit is coated on a surface of the conductive metal powder, but is not limited thereto.

If the glass frit contained in the conductive paste for an external electrode may be provided in a core-shell form in which the glass frit is coated on a surface of the conductive metal powder, the glass frit may be present in the conductive paste while having a uniform shape, thereby realizing a compact external electrode even at a low temperature.

FIG. 2 is a perspective view schematically showing a multilayer ceramic capacitor according to another embodiment of the present invention.

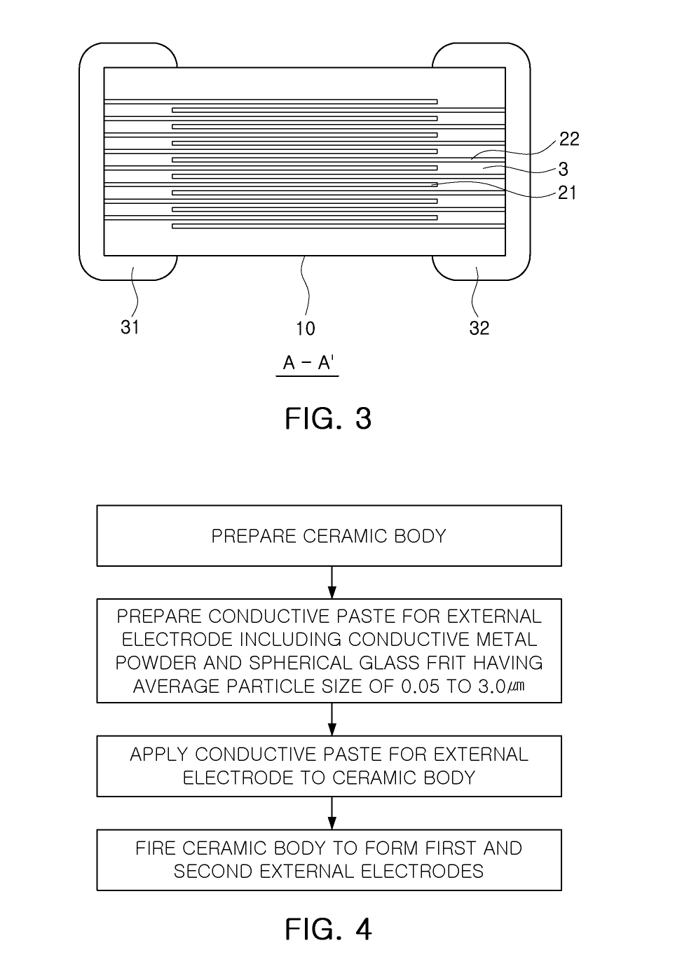

FIG. 3 is a cross-sectional view of line A-A′ of FIG. 2.

Reffering to FIGS. 2 and 3, a multilayer ceramic electronic component according to another embodiment of the presetn invention may include: a ceramic body 10 including dielectric layers 3; first and second internal electrodes 21 and 22 disposed to face each other with each dielectric layer 3 interposed therebetween within the ceramic body 10; and a first external electrode 31 electrically connected to the first internal electrodes 21 and a second external electrode 32 electrically connected to the second internal electrodes 22, wherein the first and second external electrodes 31 and 32 include a conductive metal powder and a spherical glass frit, and the glass frit has a content of 0.1 to 200 volume % based on the conductive metal powder.

Hereinafter, the multilayer ceramic electronic component according to the embodiment of the present invention will be described, in particular, as a multilayer ceramic capacitor, but the present invention is not limited thereto.

In the multilayer ceramic capacitor according to the embodiment of the present invention, a “length direction”, a “width direction”, and a “thickness direction” are defined by an “L” direction, a “W” direction, and a “T” direction of FIG. 2, respectively. Here, the ‘thickness direction’ may be used in the same concept as a direction in which the dielectric layers are laminated, that is, a ‘lamination direction’.

According to the embodiment of the present invention, a raw material for forming the dielectric layers 3 is not particularly limited as long as it allows sufficient capacitance to be obtained. For example, the raw material may be a barium titanate (BaTiO₃) powder.

As a material for forming the dielectric layers 3, various kinds of ceramic additive, an organic solvent, a plasticizer, a binder, a dispersant, or the like may be added to powder such as the barium titanate (BaTiO₃) powder or the like, depending on the purpose of the present invention.

A material for forming the first and second internal electrodes 21 and 22 is not particularly limited, and for example, a conductive paste including at least one of, for example, silver (Ag), lead (Pb), platinum (Pt), nickel (Ni), and copper (Cu) may be used therefor.

The multilayer ceramic capacitor according to the embodiment of the present invention may include the first external electrode 31 electrically connected to the first internal electrodes 21 and the second external electrode 32 electrically connected to the second internal electrodes 22.

The first and second external electrodes 31 and 32 may be electrically connected to the first and second internal electrodes 21 and 22 to form capacitance, and the second external electrode 32 maybe connected to a potential different from that of the first external electrode 31.

According to the embodiment of the present invention, the first and second external electrodes 31 and 32 may include a conductive metal powder and a spherical glass frit, and the glass frit may have a content of 0.1 to 200 volume % based on the conductive metal powder.

The spherical glass frit may have an average particle size of 0.05 to 3.0 μm, particularly, 0.05 to 1.5 μm.

Since features regarding a conductive paste for the external electrode overlap with those described in the foregoing embodiment of the present invention, descriptions thereof will be omitted.

According to the embodiment of the present invention, the first and second external electrodes 31 and 32 may include a fine-grained glass frit having a sphere shape and an average particle size of 0.05 to 3.0 μm, thereby realizing a compact external electrode even in the case of low-temperature firing and reducing crack defects due to the low-temperature firing, such that a multilayer ceramic electronic component having excellent reliability can be realized.

FIG. 4 is a view showing a process of manufacturing the multilayer ceramic capacitor according to another embodiment of the present invention.

Referring to FIG. 4, a method of manufacturing a multilayer ceramic electronic component according to another embodiment of the present invention may include: preparing the ceramic body 10 including the dielectric layers 3 and the first and second internal electrodes 21 and 22 disposed to face each other with each dielectric layer 3 interposed therebetween; preparing a conductive paste for an external electrode including a conductive metal powder and a spherical glass frit having an average particle size of 0.05 to 3.0 μm; applying the conductive paste for an external electrode to the ceramic body 10 so as to be electrically connected to the first and second internal electrodes 21 and 22; and firing the ceramic body 10 to form the first and second external electrodes 31 and 32.

The description regarding the method of manufacturing a multilayer ceramic electronic component according to the above embodiment, which overlaps with the description regarding the multilayer ceramic electronic component according to the foregoing embodiment, will be omitted.

Hereinafter, the method of manufacturing a multilayer ceramic electronic component, in particular, a multilayer ceramic capacitor, according to another embodiment of the present invention will be described in detail, but the present invention is not limited thereto.

First, the ceramic body 10 including the dielectric layers 3 and the first and second internal electrodes 21 and 22 disposed to face each other with each dielectric layer 3 interposed therebetween may be prepared.

Each dielectric layer 3 maybe formed as a ceramic green sheet, and in this case, the ceramic green sheet is fabricated as follows. Powder such as barium titanate (BaTiO₃), or the like, is mixed with a ceramic additive, an organic solvent, a plasticizer, a bonding agent, and a dispersing agent by using a basket mill to form slurry, and the slurry is applied to a carrier film and then dried to form the ceramic green sheet having a thickness of several micrometers (μm).

A conductive paste is dispensed onto the ceramic green sheet and a squeegee moves on the conductive paste in a direction, to thereby form an internal electrode layer.

Here, the conductive paste may be made of one of a precious metal such as silver (Ag), lead (Pb), platinum (Pt), or the like, and a metal such as nickel (Ni) or copper (Cu), or a combination of at least two or more thereof.

In this manner, after the internal electrode layer is formed, the ceramic green sheet is separated from the carrier film, and a plurality of the ceramic green sheets may be laminated to form a green sheet lamination.

Next, the green sheet lamination is compressed at a high temperature and pressure and then the compressed green sheet lamination is cut into a certain size through a cutting process, thus fabricating the ceramic body.

Thereafter, the conductive paste for an external electrode including a conductive metal powder and a spherical glass frit having an average particle size of 0.05 to 3.0 μm may be prepared.

A conductive metal for the conductive metal powder may be at least one selected from a group consisting of copper (Cu), nickel (Ni), silver (Ag), and silver-palladium (Ag—Pd).

The glass frit may have a content of 0.1 to 200 volume % based on the conductive metal powder.

Then, the conductive paste for an external electrode may be applied to the ceramic body 10 so as to be electrically connected to the first and second internal electrodes 21 and 22.

Finally, the ceramic body 10 may be fired to form the first and second external electrodes 31 and 32.

In addition, according to the embodiment of the present invention, the firing of the ceramic body 10 may be performed at a temperature of 700° C. or lower, but is not limited thereto.

Hereafter, the present invention will be described in detail with reference to examples, but is not limited thereto.

The examples were made to test crack occurrence and reliability in multilayer ceramic capacitors each having first and second external electrodes formed by using a conductive paste for an external electrode, including a conductive metal powder and a spherical glass frit having an average particle size of 0.05 to 3.0 μm.

Each multilayer ceramic capacitor according to the examples was manufactured through the following steps.

First, slurry including powder such as barium titanate (BaTiO₃), or the like, was applied onto a carrier film and then dried to prepare a plurality of ceramic green sheets, whereby a plurality of dielectric layers were formed.

Each dielectric layer was formed such that a thickness thereof after firing is 1 μm or less.

Then, a conductive paste for an internal electrode, including nickel particles having an average size of 0.05 to 0.2 μm, was prepared.

The conductive paste for an internal electrode was applied to the plurality of ceramic green sheets through a screen printing method in order to form internal electrodes, and two hundred (200) internal electrodes were laminated to form a lamination.

Thereafter, the lamination was compressed and cut to generate a chip having a size of 0603 standard, and the chip was sintered at a temperature ranging from 1050° C. to 1200° C. under a reduced atmosphere of H₂ equal to or less than 0.1%.

Next, an external electrode paste according to the embodiment of the present invention was used to form external electrodes, and processes such as plating and the like was performed thereon, thereby manufacturing a multilayer ceramic capacitor.

Comparative examples were manufactured in the same manner as the above manufacturing method, except that an external electrode paste according to the related art was used to form the external electrodes.

In the following Table 1, firing compactness, crack occurrence, blister occurrence, and reliability according to the average particle size and the shape of the glass frit contained in the conductive paste for an external electrode were compared.

The reliability evaluation below was based on a 8585 moisture resistance evaluation, and specifically, was conducted under test conditions of 6.3V for 12 hours, at a relative humidity of 85% and a temperature of 85° C.

TABLE 1

| | Average | | | | | Reliability |
|---|---|---|---|---|---|---|
| | Particle | | | | | Evaluation |
| | Size of | | Firing | | | (8585 Moisture- |
| | Glass Frit | Shape of | Compactness | Crack | Blister | Resistance |
| | (μm) | Glass Frit | (600° C.) | Occurrence | Occurrence | Evaluation) |
| Comparative | 0.01 | Spherical | ∘ | x | ∘ | Good |
| Example 1 | | | | | | |
| Inventive | 0.05 | Spherical | ∘ | x | x | Good |
| Example 1 | | | | | | |
| Inventive | 0.5 | Spherical | ∘ | x | x | Good |
| Example 2 | | | | | | |
| Inventive | 1.0 | Spherical | ∘ | x | x | Good |
| Example 3 | | | | | | |
| Inventive | 1.5 | Spherical | ∘ | x | x | Good |
| Example 4 | | | | | | |
| Inventive | 2.0 | Spherical | ∘ | x | x | Good |
| Example 5 | | | | | | |
| Inventive | 3.0 | Spherical | ∘ | x | x | Good |
| Example 6 | | | | | | |
| Comparative | 3.5 | Spherical | Δ | ∘ | x | Bad |
| Example 2 | | | | | | |
| Comparative | 5.0 | — | x | ∘ | x | Bad |
| Example 3 | | | | | | |

(Here, ∘ is good, Δ is normal, and x is defect).

Referring to [Table 1], an average particle size of the glass frit was 0.01 μm and 3.5 μm, respectively, in comparative examples 1 and 2, and these values deviate from the numerical range according to the embodiment of the present invention. It can be seen that cracks occurred due to electrode firing and reliability was deteriorated in comparative examples 1 and 2.

In addition, comparative example 3 includes a glass frit of the related art having an irregular shape and an average particle size of 5.0 μm. It can be seen that cracks occurred due to electrode firing and reliability was deteriorated in comparative example 3.

On the other hand, inventive examples 1 to 6 satisfy the numerical range according to the embodiment of the present invention. Here, it can be seen that cracks was not generated and excellent reliability was exhibited in the case of using the conductive paste for an external electrode, including a spherical glass frit having an average particle size of 0.05 to 3.0 μM.

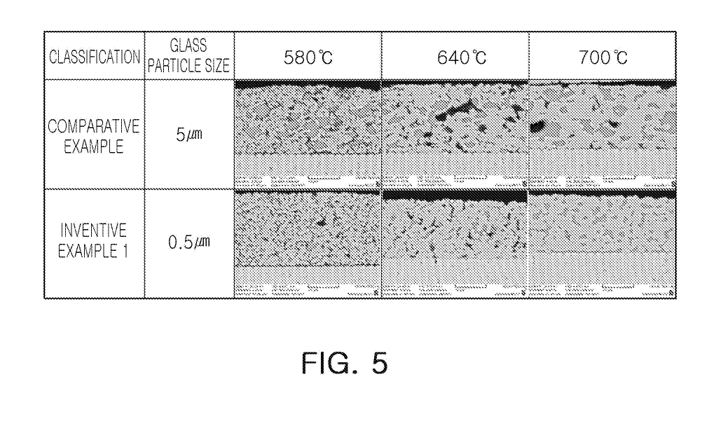

FIG. 5 shows scanning electron microscope (SEM) paragraphs showing cross sections of external electrodes for individual firing temperatures according to inventive examples and comparative examples of the present invention.

Referring to FIG. 5, it can be seen that very excellent compactness was exhibited when a firing temperature of an external electrode including a spherical glass frit having an average particle size of 0.5 μm, as the inventive example of the present invention, is 700° C.

On the other hand, it can be seen that compactness defects occurred when the firing temperature of the external electrode including an irregular-shape glass frit having an average particle size of 5.0 μm, as the comparative example of the present invention, is 700° C.

Therefore, according to the embodiment of the present invention, the first and second external electrodes are formed by using the conductive paste including a spherical glass frit having an average particle size of 0.05 to 3.0 μM, whereby a multilayer ceramic electronic component capable of preventing crack defects and realizing excellent reliability may be implemented.

As set forth above, according to the embodiments of the present invention, a spherical glass frit having fine particles may be applied at the time of preparing the conductive paste for an external electrode, thereby realizing external electrodes having excellent compactness at a low temperature and suppressing the occurrence of cracks, and thus, a multilayer ceramic electronic component having excellent reliability can be manufactured.

While the present invention has been shown and described in connection with the above-described embodiments, it will be apparent to those in the art that modifications and variations can be made without departing from the spirit and scope of the invention as defined by the appended claims.

What is claimed is:

1. A conductive paste for an external electrode, comprising:
a conductive metal powder; and
a spherical glass frit having an average particle size of 0.05 to 3.0 μm.

2. The conductive paste of claim 1, wherein the spherical glass frit has an average particle size of 0.05 to 1.5 μm.

3. The conductive paste of claim 1, wherein the glass frit has a content of 0.1 to 200 volume % based on the conductive metal powder.

4. The conductive paste of claim 1, wherein the glass frit is provided in powder form, or in a core-shell form in which the glass frit is coated on a surface of the conductive metal powder.

5. The conductive paste of claim 1, wherein a conductive metal for the conductive metal powder is at least one selected from a group consisting of copper (Cu), nickel (Ni), silver (Ag), and silver-palladium (Ag—Pd).

6. A multilayer ceramic electronic component, comprising:
a ceramic body including dielectric layers;
first and second internal electrodes disposed to face each other with each dielectric layer interposed therebetween within the ceramic body; and
a first external electrode electrically connected to the first internal electrodes and a second external electrode electrically connected to the second internal electrodes,
wherein the first and second external electrodes include a conductive metal powder and a spherical glass frit, and the glass frit has a content of 0.1 to 200 volume % based on the conductive metal powder.

7. The multilayer ceramic electronic component of claim 6, wherein the spherical glass frit has an average particle size of 0.05 to 3.0 μm.

8. The multilayer ceramic electronic component of claim 6, wherein the spherical glass frit has an average particle size of 0.05 to 1.5 μm.

9. The multilayer ceramic electronic component of claim 6, wherein a conductive metal for the conductive metal powder is at least one selected from a group consisting of copper (Cu), nickel (Ni), silver (Ag), and silver-palladium (Ag—Pd).

10. A method of manufacturing a multilayer ceramic electronic component, the method comprising:
preparing a ceramic body including dielectric layers and first and second internal electrodes disposed to face each other with each dielectric layer interposed therebetween;
preparing a conductive paste for an external electrode including a conductive metal powder and a spherical glass frit having an average particle size of 0.05 to 3.0 μm;
applying the conductive paste for an external electrode to the ceramic body so as to be electrically connected to the first and second internal electrodes; and
firing the ceramic body to form first and second external electrodes.

11. The method of claim 10, wherein the spherical glass frit has an average particle size of 0.05 to 1.5 μm.

12. The method of claim 10, wherein the glass frit has a content of 0.1 to 200 volume % based on the conductive metal powder.

13. The method of claim 10, wherein the glass frit is provided in powder form, or in a core-shell form in which the glass frit is coated on a surface of the conductive metal powder.

14. The method of claim 10, wherein a conductive metal for the conductive metal powder is at least one selected from a group consisting of copper (Cu), nickel (Ni), silver (Ag), and silver-palladium (Ag—Pd).

15. The method of claim 10, wherein the firing of the ceramic body is performed at a temperature of 700° C. or lower.
